(19) United States
(12) Patent Application Publication
(10) Pub. No.: US 2014/0183280 A1
(43) Pub. Date: Jul. 3, 2014

(54) Flow Device

(71) Applicant: Mehri Mafi, San Jose, CA (US)

(72) Inventors: Mehri Mafi, San Jose, CA (US); Maryam Mafi, San Jose, CA (US)

(21) Appl. No.: 14/100,273

(22) Filed: Dec. 9, 2013

Related U.S. Application Data
(60) Provisional application No. 61/797,540, filed on Dec. 10, 2012.

(51) Int. Cl. B05B 7/30; B05B 7/00

(52) U.S. Cl. CPC B05B 11/30
USPC 239/318; 222/630

(57) ABSTRACT

A flow device automatically impels a fluid to disperse from a container without requiring significant physical exertion, such as a repetitive pumping motion, to propel the fluid through. The flow device automatically causes an intake fluid to flow from an intake end of a container, and pass through an interior channel of the container. The intake fluid helps force a dispersion fluid inside the container to disperse through an opposite, dispersion end without requiring a manual motion, such as a pumping action with a finger. The flow device includes a switch that actuates a pressure differentiation portion, such as a fan, vacuum, pump, or compressor, to create a vacuum or redirection of intake fluid within the container sufficient to create the flow for the intake fluid to pass through the container. The automatic switch negates the need to flex and stress joints in a hand.

### CROSS-REFERENCE TO RELATED APPLICATIONS

The present Utility patent application claims priority benefit of the U.S. provisional application for patent Ser. No. 61/797,540 titled “Quick Spray,” filed on Dec. 10, 2012 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a flow device. More particularly, the invention relates to a spray device that automatically creates flow in a container with minimal physical exertion.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a spray bottle is a bottle that can squirt, spray or mist fluids. A common use for spray bottles is dispensing cool cleaners, cosmetics, and chemical specialties.

Often, a mechanical fan is a machine used to create flow within a fluid, typically a gas such as air. The fan consists of a rotating arrangement of vanes or blades which act on the air. The rotating assembly of blades and hub is known as an impeller, a rotor, or a runner. Usually, it is contained within some form of housing or case. This may direct the airflow or increase safety by preventing objects from contacting the fan blades. Most fans are powered by electrical motors.

In many instances, fans produce air flows with high volume and low pressure. A fan blade rotates when exposed to an air stream. The air stream can impel a liquid to pass through a channel. Additionally, compressors produce high pressures at a comparatively low volume to force a fluid through a channel.

Typically, a switch is an electrical component that can break an electrical circuit, interrupting the current or diverting it from one conductor to another. The most familiar form of switch is a manually operated electromechanical device with one or more sets of electrical contacts, which are connected to external circuits.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary flow device dispersing an exemplary fluid, in accordance with an embodiment of the present invention;

FIG. 2 illustrates a sectioned view of an exemplary flow device with an attached accessory container, in accordance with an embodiment of the present invention; and

FIG. 3 illustrates a detailed perspective view of an exemplary pressure differentiation portion creating flow, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings.

There are various types of flow devices that may be provided by preferred embodiments of the present invention. In one embodiment of the present invention, the flow device may automatically impel a fluid to disperse from a container without requiring significant physical exertion to propel the fluid through. In one embodiment, the flow device may automatically cause an intake fluid to flow from an intake end of a container, and pass through an interior channel of the container. The intake fluid may help force a dispersion fluid inside the container to disperse through an opposite, dispersion end without requiring a manual motion, such as a pumping action with a finger. The flow device may include a switch that actuates an impeller, such as a fan, vacuum, pump, or compressor, to create a pressure differentiation within the container that is sufficient to create the flow of the intake fluid through the container. The switch may negate the need to flex and stress joints in a hand to generate dispersion by pumping a trigger. Those skilled in the art, in light of the present teachings, will recognize that repetitive movement of the fingers may be painful and problematic for a user suffering from arthritis or carpel tunnel syndrome. Automating the dispersion of the dispersion fluid with a mechanical impeller may require less physical movement, such as repetitively flipping a switch.

In one embodiment of the present invention, the flow device may retain a dispersion fluid inside a container, such as a spray bottle. The container may be sized and dimensioned to at least partially enable an intake fluid to pass through, and force the dispersion fluid out from the container. In some embodiments, a pressure differentiation portion may help impel the intake fluid through the container, thereby creating a flow. The pressure differentiation portion may include an impeller intake portion for receiving the intake fluid. The pressure differentiation portion may further comprise an impeller that rotates to force the intake fluid through the impeller, and out through an impeller output portion. From the impeller output portion, a flow may be created that passes through the container. This subsequent flow may create a vacuum inside the container that is sufficient to help the intake fluid enter the intake end through an intake aperture.

In some embodiments, a switch may actuate the pressure differentiation portion. It is significant to note that powering on and off the pressure differentiation portion with the switch may require less physical exertion than repetitively pressing on a pump mechanism. A switch regulation portion may include a mechanism for transferring movement from the switch into rotation in the impeller portion. Once forced into the container, the intake fluid may flow through an interior channel inside the container. The interior channel may extend through the dispersion fluid, allowing the intake fluid and the dispersion fluid to at least partially mix. The dispersion fluid may include a separate fluid, or a combination of both the intake fluid and the dispersion fluid, such as a mist. The interior channel may terminate at a dispersion end, allowing the dispersion fluid to exit through a dispersion aperture.

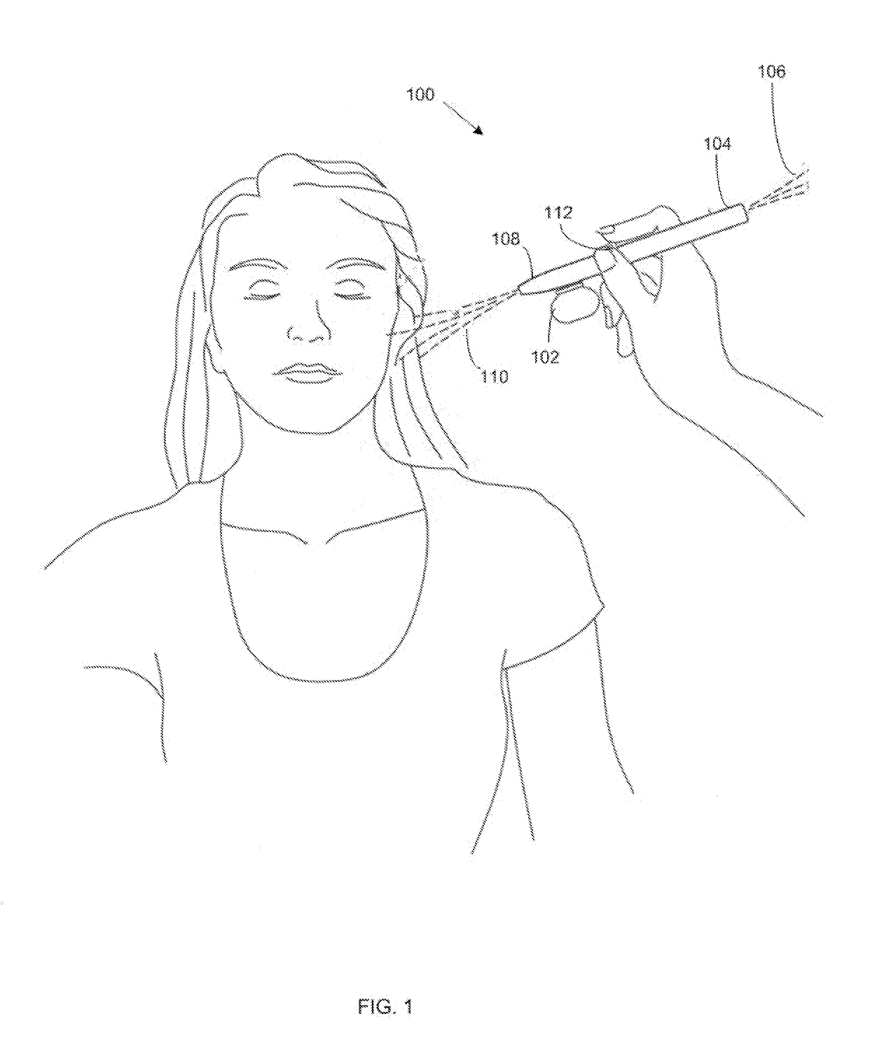

FIG. 1 illustrates a detailed perspective view of an exemplary flow device dispersing an exemplary fluid, in accordance with an embodiment of the present invention. In the present invention, a flow device 100 may automatically impel a fluid to disperse from a container 102. The automation allows a user to disperse a fluid from the container with minimal physical exertion of the joints. The container may include, without limitation, a spray bottle. The container may be utilized for dispensing various liquids, including, without limitation, cleaners, cosmetics, chemical specialties, liquid mixtures, and vapors.

In one embodiment, the flow device may automatically cause an intake fluid 106 to flow from an intake end 104 of a container, and pass through an interior channel of the container. The intake fluid may include, without limitation, ambient air, a compressed gas, and a pressurized liquid. The intake fluid may create sufficient pressure to force a dispersion fluid 110 inside the container to disperse through an opposite, dispersion end 108 without requiring a manual motion, such as a pumping action with a finger. The flow device may include a switch 112 that actuates an impeller, which may include, without limitation, a fan, vacuum, or generator, to create a pressure differentiation within the container sufficient to create the flow of the intake fluid through the container. The switch may include, without limitation, an On/Off switch, a button, and a lever. In one embodiment, the switch may include a velocity regulator for adjusting the diameter of the interior channel or valves inside the interior channel. The switch may negate the need to flex and stress joints in a hand to generate dispersion by pumping a trigger. Those skilled in the art, in light of the present teachings, will recognize that repetitive movement of the fingers may be painful and problematic for a user suffering from arthritis or carpel tunnel syndrome. Automating the dispersion of the dispersion fluid with a mechanical impeller may require less physical movement, such as repetitively oscillating a pump.

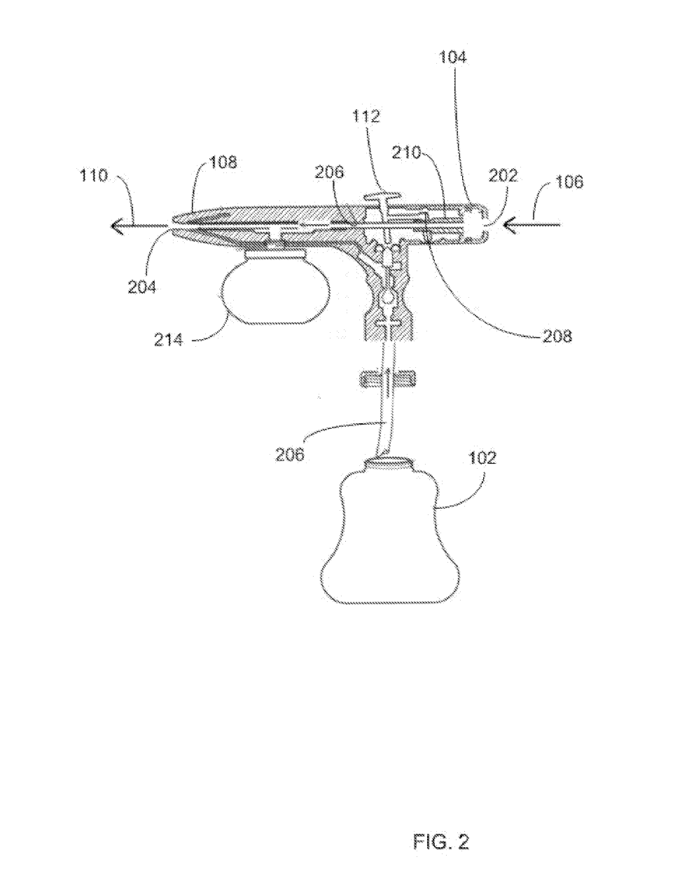

FIG. 2 illustrates a sectioned view of an exemplary flow device with an attached accessory container, in accordance with an embodiment of the present invention. In the present invention, the flow device may retain a dispersion fluid inside a container, such as a spray bottle. The container may be sized and dimensioned to at least partially enable an intake fluid to pass through the interior channel, and force the dispersion fluid out from the container. In some embodiments, a pressure differentiation portion 210 may help impel the intake fluid through the container, thereby creating a flow. The pressure differentiation portion may create a vacuum inside the container that is sufficient to help the intake fluid enter through an intake aperture 202 in the intake end.

In some embodiments, a switch may actuate the pressure differentiation portion. It is significant to note that powering on and off the pressure differentiation portion with the switch may require less physical exertion than repetitively pressing on a pump mechanism. A switch regulation portion 208 may include a mechanism for transferring movement from the switch into rotation in the impeller portion. Once forced into the container, the intake fluid may flow through an interior channel 206 inside the container. The interior channel may extend through the dispersion fluid, allowing the intake fluid and the dispersion fluid to at least partially mix. The dispersion fluid may include a separate fluid, or a combination of both the intake fluid and the dispersion fluid, such as a mist. In one embodiment, the container may join with the interior channel through a variety of three cap sizes. The interior channel may terminate at a dispersion end, allowing the dispersion fluid to exit through a dispersion aperture 204. In one embodiment, an accessory container 214 may join with the interior channel. The accessory container may contain an additional fluid, different than the fluid contained in the container. The pressurized flow may passes over both the container and the accessory container creating a vacuum in proximity to each. In this manner, two separate fluids may be combined and dispersed.

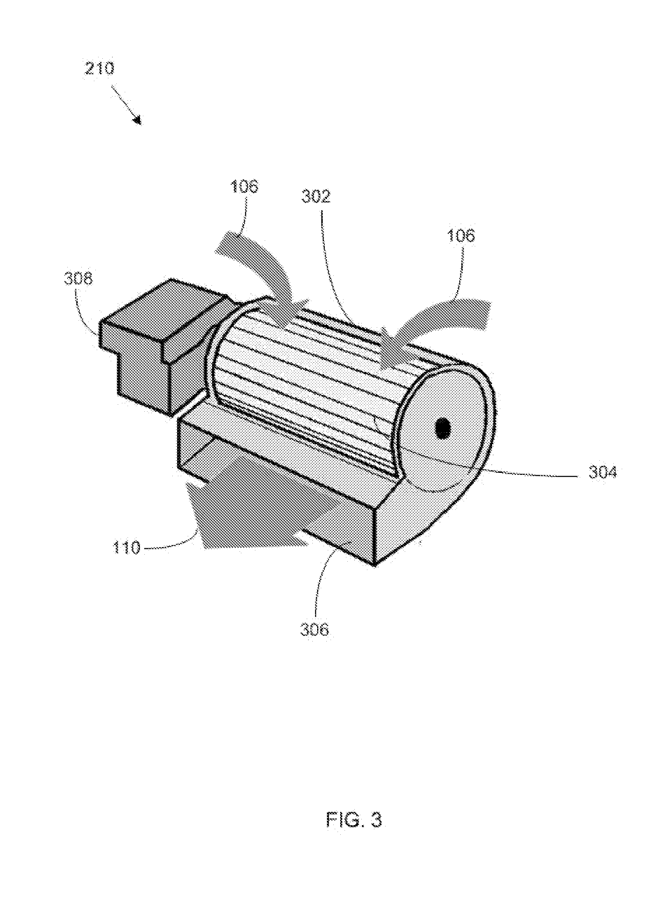

FIG. 3 illustrates a detailed perspective view of an exemplary pressure differentiation portion creating flow, in accordance with an embodiment of the present invention. In the present invention, a pressure differentiation portion may help impel the intake fluid through the container, thereby creating a flow. In some embodiments, the flow may create a vacuum inside the container that is sufficient to help the intake fluid enter the intake end through an intake aperture. In some embodiments, the pressure differentiation portion may include, without limitation, a centrifugal fan, an axial-flow fan, and a compressor. The pressure differentiation portion may include an impeller intake portion 302 for receiving the intake fluid. The pressure differentiation portion may further comprise an impeller 304 that rotates to force the intake fluid through the impeller, and out an impeller output portion 306. From the impeller output portion, a flow may be created that passes through the interior portion of the container. The pressure differentiation portion may function in various manners. In one embodiment, the pressure differentiation portion comprises an impeller having a rotating arrangement of vanes or blades which act on the intake fluid directing the flow through the interior channel. The subsequent flow passes in proximity to the dispersion fluid, thereby creating a vacuum. The dispersion fluid may then fill the vacuum and disperse from the container accordingly. In yet another embodiment, the pressure differentiation portion includes a compressor that increases the pressure of the intake fluid by reducing its volume. The reduced volume of the intake fluid and the interior channel create sufficient pressure to create a flow through the container. In some embodiments, an impeller power source 308 may power a motor in the pressure differentiation portion. The impeller power source may include, without limitation, a battery, a rechargeable battery, an exterior power source, and a solar panel.

In one alternative embodiment, the flow device joins with an exterior tube that carries a fluid into the interior channel. The exterior tube may enable an additional fluid to enter the container. In yet another alternative embodiment, the switch includes variable speeds. In yet another alternative embodiment, the container includes a propellant to increase the rate of flow for the intake fluid, or to serve as the intake fluid.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a dispersion device that creates an automated flow for a fluid according to the present invention will be apparent to those skilled in the art. Various aspects of the invention have been described above by way of illustration, and the specific embodiments disclosed are not intended to limit the invention to the particular forms disclosed. The particular implementation of the dispersion device that creates an automated flow for a fluid may vary depending upon the particular context or application. By way of example, and not limitation, the flow device intakes air from one end and outputs the air from an opposite end with an internal impeller described in the foregoing were principally directed to a tent filled with air, and having multiple layers for insulation and contouring the ground surface implementations; however, similar techniques may instead be applied to permanent building structures, such as offices, houses, and warehouses filled with air and having multiple rigid layers, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A device comprising:
a container, said container being configured to at least partially carry at least one fluid through an interior channel, said container comprising an intake end, said intake end being configured to at least partially receive an intake fluid, said container further comprising a dispersion end, said dispersion end being configured to at least partially disperse a dispersion fluid and/or said intake fluid;
a pressure differentiation portion, said pressure differentiation portion being configured to create a vacuum, said vacuum being operable to help force said intake fluid and/or said dispersion fluid through said interior channel; and
a switch, said switch being configured to actuate said pressure differentiation portion.

2. The device of claim 1, in which said container comprises a spray bottle.

3. The device of claim 2, in which said intake fluid comprises air.

4. The device of claim 3, in which said dispersion fluid comprises a vapor.

5. The device of claim 4, in which said intake end comprises an intake aperture, said intake aperture being configured to enable at least partial entry of said intake fluid into said interior channel.

6. The device of claim 5, in which said dispersion end comprises a dispersion aperture, said dispersion aperture being configured to enable at least partial dispersion of said intake fluid and/or said dispersion fluid from said interior channel.

7. The device of claim 6, in which said pressure differentiation portion comprises a fan.

8. The device of claim 7, in which said fan comprises an impeller, said impeller being configured to rotatably impel said intake fluid through said interior channel.

9. The device of claim 8, in which said impeller comprises an impeller intake portion, said impeller intake portion being configured to at least partially enable said intake fluid to enter said impeller.

10. The device of claim 9, in which said impeller comprises an impeller output portion, said impeller output portion being configured to at least partially enable said intake fluid to disperse from said impeller.

11. The device of claim 10, in which said switch comprises a button, said button comprising a power selection, said power selection comprising an on position and an off position.

12. The device of claim 11, in which said switch comprises a switch regulation portion, said switch regulation portion being configured to transfer movement from said switch into rotation to said impeller.

13. The device of claim 12, in which said device comprises an accessory container, said accessory container being configured to contain an additional fluid.

14. The device of claim 13, in which said impeller comprises an impeller power source, said impeller power source being configured to power said impeller.

15. The device of claim 14, in which said impeller power source comprises a rechargeable battery.

16. The device of claim 15, wherein said container joins said interior channel with three cap sizes.

17. A device comprising:
means for filling a container with a dispersion fluid;
means for receiving an intake fluid through an intake aperture;
means for manipulating a switch;
means for actuating a pressure differentiation portion;
means for impelling said intake fluid and/or said dispersion fluid through an interior channel; and
means for dispersing said intake fluid and/or said dispersion fluid through a dispersion aperture.

18. A device consisting of:
a container, said container comprising a spray bottle, said container being configured to at least partially carry at least one fluid through an interior channel, said container comprising an intake end, said intake end being configured to at least partially receive an intake fluid, said intake end comprising an intake aperture, said intake aperture being configured to enable at least partial entry of said intake fluid into said interior channel, said container further comprising a dispersion end, said dispersion end being configured to at least partially disperse a dispersion fluid and/or said intake fluid;
a pressure differentiation portion, said pressure differentiation portion being configured to create a vacuum, said vacuum being operable to help force said intake fluid and/or said dispersion fluid through said interior channel, said pressure differentiation portion comprising a fan, said fan comprising an impeller, said impeller being configured to rotatably impel said intake fluid through said interior channel, said impeller comprising an impeller intake portion, said impeller intake portion being configured to at least partially enable said intake fluid to enter said impeller, said impeller comprising an impeller output portion, said impeller output portion being configured to at least partially enable said intake fluid to disperse from said impeller; and
a switch, said switch being configured to actuate said pressure differentiation portion, said switch comprising a button, said button comprising a power selection, said power selection comprising an on position and an off position, said switch further comprising a switch regulation portion, said switch regulation portion being configured to transfer movement from said switch into rotation to said impeller.
